(19) United States
(12) Patent Application Publication
(10) Pub. No.: US 2024/0257168 A1
(43) Pub. Date: Aug. 1, 2024

(54) AUDIENCE SEGMENT FINGERPRINTING AND SIMILARITY

(71) Applicant: Salesforce, Inc., San Francisco, CA (US)

(72) Inventors: Yuxi Zhang, San Francisco, CA (US); Kexin Xie, San Mateo, CA (US); Max Fleming, San Francisco, CA (US)

(21) Appl. No.: 18/102,558

(22) Filed: Jan. 27, 2023

(51) Int. Cl. G06Q 30/0204; G06Q 30/0202

(52) U.S. Cl. CPC G06Q 30/0205; G06Q 30/0202

(57) ABSTRACT

Methods, systems, apparatuses, devices, and computer program products are described. A modeling service may generate a set of candidate segments using a set of cluster models and based on a seed segment and entity data. Based on respective features associated with the segments, the service may generate candidate segment fingerprints and a seed segment fingerprint, where a segment fingerprint may indicate a distribution of entities within a segment based on similarities between features associated with entities within the segment. That is, a segment fingerprint may depict how similar entities are in a candidate segment based on different features. The service may calculate similarity scores between the seed segment and the candidate segments using the segment fingerprints, and rank entities in terms of their similarity. The highest ranking entities may be identified from the candidate segments and included in a lookalike segment corresponding to the seed segment.

### FIELD OF TECHNOLOGY

The present disclosure relates generally to database systems and data processing, and more specifically to audience segment fingerprinting and similarity.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support systems that are used identify lookalike segments of users that have similar features and behaviors as a seed segment. Different approaches for lookalike modeling may include segment approximation-based models that rely on pre-built segments to identify similar users, similarity-based models that use user-to-user (U2U) similarity to identify segment similarity, and classification or regression-based models trained to identify users that may belong to a seed segment. However, each of these approaches to lookalike modeling may have limitations. For example, these models may be computationally expensive, rely on pre-built segments or user features that may not be available, or overfit users to a seed segment, among other limitations.

### BRIEF DESCRIPTION OF THE DRAWINGS

FIG. 1 illustrates an example of a data processing system that supports audience segment fingerprinting and similarity in accordance with aspects of the present disclosure.

FIG. 2 illustrates an example of a computing architecture that supports audience segment fingerprinting and similarity in accordance with aspects of the present disclosure.

FIG. 3 illustrates an example of a two-layer model that supports audience segment fingerprinting and similarity in accordance with aspects of the present disclosure.

FIG. 4 illustrates an example of segment fingerprints that support audience segment fingerprinting and similarity in accordance with aspects of the present disclosure.

FIG. 5 illustrates an example of a combinatorial model that supports audience segment fingerprinting and similarity in accordance with aspects of the present disclosure.

FIG. 6 illustrates an example of a process flow that supports audience segment fingerprinting and similarity in accordance with aspects of the present disclosure.

FIG. 7 illustrates a block diagram of an apparatus that supports audience segment fingerprinting and similarity in accordance with aspects of the present disclosure.

FIG. 8 illustrates a block diagram of a data processor that supports audience segment fingerprinting and similarity in accordance with aspects of the present disclosure.

FIG. 9 illustrates a diagram of a system including a device that supports audience segment fingerprinting and similarity in accordance with aspects of the present disclosure.

FIGS. 10 through 13 illustrate flowcharts showing methods that support audience segment fingerprinting and similarity in accordance with aspects of the present disclosure.

### DETAILED DESCRIPTION

A lookalike modeling service may support cluster modeling and combinatorial modeling for audience segment fingerprinting and automatic similarity (e.g., lookalike) discovery. For example, an organization or tenant may use the lookalike modeling service to discover similar users at scale while automatically revealing attributes or user features that contribute to that similarity, where the users may be examples of subscribers, customers, or prospective customers of the organization. The lookalike modeling service may utilize a cluster model and a combinatorial model to efficiently profile segments of users and measure similarity between the segments, which may improve computational efficiency compared to existing methods.

Techniques described herein support profiling segments using fingerprinting and measuring segment similarity to discover lookalike segments and users (e.g., entities). A lookalike modeling service may use a seed segment, a set of entity data, and a set of cluster models to generate a set of candidate segments. A cluster model may be a machine learning model associated with a group of attributes or features with common characteristics. A candidate segment may include a segment of lookalike users recommended based on the features associated with the corresponding cluster model. Using respective features associated with the set of candidate segments and the seed segment, a model may generate a set of candidate segment fingerprints and a seed segment fingerprint. A segment fingerprint may indicate a distribution of users within a segment based on similarities between features associated with entities within the segment. For example, a segment fingerprint may indicate a distribution of users based on their demographic information.

In some examples, the set of candidate segment fingerprints and the seed segment fingerprint may be used to calculate a set of similarity scores between each candidate segment and the seed segment. The similarity scores may be based on a set of divergence scores that measures how distinguishable each candidate segment is from the seed segment. In some examples, the set of similarity scores may be used to identify a segment of lookalike users that correspond to the seed segment from the set of candidate segments. For example, based on the divergence scores, a combinatorial model may merge the candidate segments to identify candidate segments that are most similar to the seed segment, rank the entities segment, and identify most similar entities (e.g., users) to make up the segment of lookalike users. In addition, the combinatorial model may identify top factors (e.g., features, attributes) that contribute to the similarity.

Segment fingerprinting and lookalike discovery, as described herein, may support increased computational efficiency, improved similarity scoring at scale, and improved accessibility to similarity scoring for small and new organizations, among other benefits. For example, as the techniques described herein support cluster modeling, segment fingerprinting, and combinatorial modeling, calculating segment similarity as described herein may be more computationally efficient as compared to other approaches. In addition, such segment fingerprinting may provide additional insights and value to organizations regarding candidate segments. Moreover, the techniques described herein may perform efficiently with hyper-dimensional features of various types (e.g., personal demographic information, product affinities, etc.), which may improve similarity scoring at scale. Additionally, the techniques described herein support candidate segment generation using the cluster modeling, a seed segment, and user data, which may not require the use of pre-built segments and thus allow new or small organizations (without access to pre-built segments) to utilize the described techniques.

Aspects of the disclosure are initially described in the context of an environment supporting an on-demand database service. Aspects of the disclosure are then described in the context of computing architectures, two-layer models, segment fingerprints, combinatorial models, and process flows. Aspects of the disclosure are further illustrated by and described with reference to apparatus diagrams, system diagrams, and flowcharts that relate to audience segment fingerprinting and similarity.

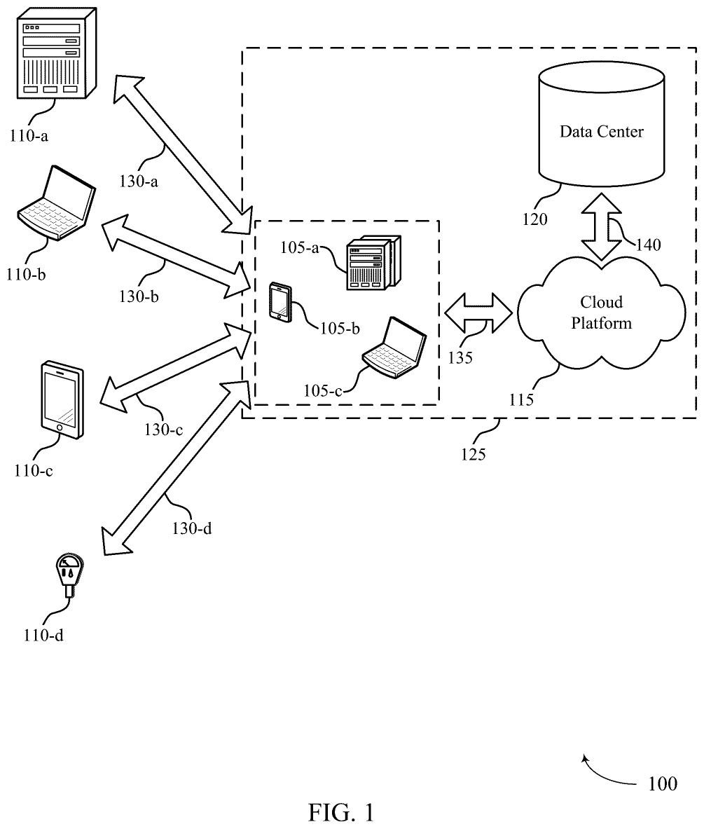

FIG. 1 illustrates an example of a system 100 for cloud computing that supports audience segment fingerprinting and similarity in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

One or both of the cloud platform 115 or the subsystem 125 may support a lookalike modeling service, which may be used for audience segment fingerprinting and automatic lookalike discovery. Lookalike modeling is a process that identifies users (e.g., customers) who look and behave as a target audience based on user features or attributes (e.g., interests, activity patterns, demographic information). These attributes may be stored in association with user identifiers at the data center 120. An organization may use lookalike modeling to grow customer pools for marketing campaigns and other marketing purposes. For example, a business may identify a segment of customers who have recently purchased a product. Lookalike modeling may help the business identify a pool of possible customers who share common characteristics with the segment of customers that also have a high propensity to purchase the same products.

Existing lookalike modeling techniques may include segment approximation-based approaches, similarity-based approaches, or classification or regression-based approaches. Segment approximation-based approaches may use pre-built segments of users as features to identify segments that may be shared by as many seed users as possible. Such approaches may efficiently identify lookalikes if there are at least a particular quantity of pre-built segments. However, these approaches may fail for new businesses that lack access to pre-built segments. Moreover, calculating segment overlaps for large segments may be computationally expensive using a segment approximation-based approach, which may limit segment sizes.

Similarity-based approaches may include calculating user-to-user (U2U) similarity to approximate segment similarity. Features such as geolocation, gender, and other demographic information may be used to identify similar users. The performance of similarity-based approaches may depend largely on selecting the correct features and similarity functions. In addition, an amount of calculation and computational resources required for U2U similarity may grow exponentially as the size of the segment increases.

Classification or regression-based models may use manually-crafted user features to train a classifier or regression model to identify users that may have a high chance of belonging to a seed segment. Such models may overfit users to the seed segment when the seed segment is small. The segment approximation, similarity, and classification or regression-based approaches may fail when their respective models are based on various dimensional attributes, such as static profile and preference information, dynamic engagement history across multiple channels, and factorized high-dimensional user latent factors regarding product affinities, among other attributes. The feature space may become exponentially large for these models, and the dimensions may be unequal. As such, only some attributes or features may be used to train a model as treating the attributes equally may fail to dynamically discover segment key attributes.

To improve computational efficiency, similarity scoring at scale, and accessibility of similarity scoring, the data processing system 100 may support a lookalike modeling service for audience segment fingerprinting and automatic lookalike discovery. A lookalike modeling service may use a seed segment, a set of entity data, and a set of cluster models to generate a set of candidate segments. A cluster model may be a machine learning model associated with a group of attributes or features with common characteristics, and a candidate segment may include a segment of recommended lookalike users. Using respective features associated with the set of candidate segments and the seed segment, a model may generate a set of candidate segment fingerprints and a seed segment fingerprint. A segment fingerprint may indicate a distribution of users within a segment based on similarities between features associated with entities within the segment. For example, a segment fingerprint may indicate a distribution of users based on their demographic information.

The set of candidate segment fingerprints and the seed segment fingerprint may be used to calculate a set of similarity scores between each candidate segment and the seed segment. The similarity scores may be based on a set of divergence scores that measures how distinguishable the candidate segments are from the seed segment. In some examples, the set of similarity scores may be used to identify a segment of lookalike users that correspond to the seed segment from the set of candidate segments. For example, based on the divergence scores, a combinatorial model may merge the candidate segments to identify candidate entities that are most similar to the seed segment. In addition, the combinatorial model may identify top factors (e.g., features, attributes) that contribute to the similarity.

In some examples, an administrative user (e.g., a marketer) may use the techniques described herein to identify a pool of potential customers. For example, a seed segment may include users who recently purchased a particular product. After generating a set of candidate segments and a set of corresponding candidate segment fingerprints and performing similarity scoring, the administrative user may identify a set of potential customers that look and behave similarly to the seed segment, and thus who also may purchase the product. Alternatively, the administrative user may use the techniques for segment fingerprinting as described herein to identify similarities between populations. For example, segment fingerprinting may depict similarities in features between a first segment of users located in California and a second segment of users located in Texas, such as salary and demographic information.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

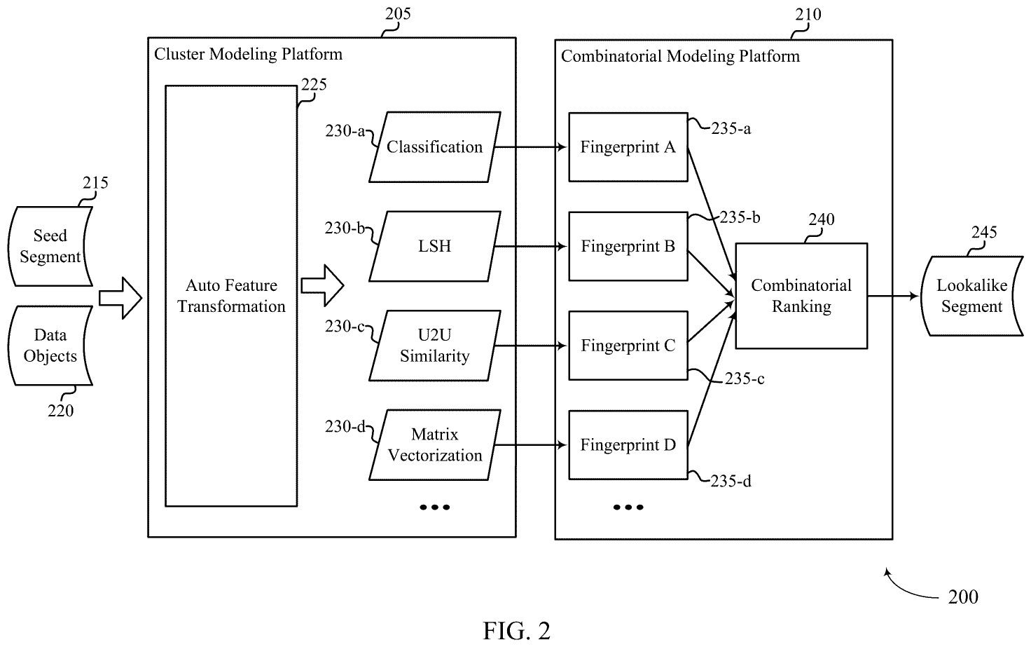

FIG. 2 illustrates an example of a computing architecture 200 that supports audience segment fingerprinting and similarity in accordance with aspects of the present disclosure. The computing architecture 200 may implement or be implemented by aspects of the data processing system 100. For example, the computing architecture 200 may include a cluster modeling platform 205 and a combinatorial modeling platform 210, each of which may be implemented by aspects of a cloud platform 115 or a subsystem 125 described with reference to FIG. 1. In some examples, the systems or servers supporting the cluster modeling platform 205 may include computing systems that are logically or physically separated from systems or servers supporting the combinatorial modeling platform 210.

The computing architecture 200 may support a two-layer model approach for segment fingerprinting and lookalike discovery based on the cluster modeling platform 205 and the combinatorial modeling platform 210. The cluster modeling platform 205 may include multiple cluster models 230 each associated with a cluster (e.g., group) of features that share common characteristics. In addition, each cluster model 230 may be a different type of machine learning model suitable for lookalike modeling based on the types of features associated with the cluster model. For example, a cluster model 230-a may be a classification or regression model, a cluster model 230-b may be a locality-sensitive hashing (LSH) model, a cluster model 230-c may be a user-to-user (U2U) similarity model, and a cluster model 230-d may be a matrix vectorization model. Other machine learning models may be used for the cluster models 230 based on the different feature types. Additionally, the cluster modeling platform 205 may include multiple instances of the same type of cluster model 230-b. For example, a first LSH model (e.g., cluster model 230)-b) may be used to process attributes associated with web-behavior, and a second LSH model (e.g., cluster model 230)-b) may be used to process attributes associated with purchase history. As described in further detail herein, the first LSH model may output a first candidate segment, and the second LSH model may output a second candidate segment.

A set of data objects 220 (e.g., a corpus of entity data) may be input to the cluster modeling platform 205. The data objects 220 may include user profile data, demographic information, product purchase history, and product affinities, among other features, attributes, or behaviors of users. Additionally, the cluster modeling platform 205 may utilize a seed segment 215, which may include users (e.g., entities) with similar features or behaviors. For example, the seed segment 215 may include users who purchased a same product or live in a same region. The seed segment 215 and the data objects 220 may be input to the cluster modeling platform 205. The data objects 220 may undergo an automatic feature transformation 225 to sort different features (e.g., attributes) associated with the data objects 220 into feature types.

In some examples, a set of candidate segments may be generated using the cluster models 230 and based on the seed segment 215 and the data objects 220. In this way, the data objects 220 may be input to a particular cluster model 230 based on the features identified in the automatic feature transformation 225 such that each cluster model 230 is associated with features of a feature type. Using the automatic feature transformation 225 may enable an organization to efficiently model the candidate segments using many different types of features or attributes at scale, where the features may include different types of data (retrieved from marketing, sales, service, and other applications) including user profiles, engagement events, purchase history, and product affinities, among other features.

A candidate segment may include a set of multiple entity identifiers (where an entity corresponds to a user) from the data objects 220 that correspond to a list of recommended lookalike users with a confidence score specific to that cluster model 230. That is, a set of confidence scores may be generated for the entities of the set of candidate segments using the cluster models 230. A confidence score may indicate a probability of entity classification into a respective candidate segment of the set of candidate segments (e.g., each candidate segment may include similar users).

Because each cluster model 230 may be based on a different machine learning model and a different feature type, each cluster model 230 may use different scoring metrics for scoring similarities between users. As such, the candidate segments as they are output by the cluster modeling platform 205 may not be directly comparable. To combine the candidate segments and rank similarities between the candidate segments and the seed segment in a meaningful way, the combinatorial modeling platform 210 may leverage a seed segment fingerprint and a set of candidate segment fingerprints 235.

The seed segment fingerprint and the candidate segment fingerprints 235 (corresponding to the seed segment 215 and the set of candidate segments, respectively) may be generated based on respective sets of features associated with entities of each of the candidate segments and the seed segment 215. A segment fingerprint may be a projection of users to a lower dimensional space, where similar users (in terms of the feature space) may be projected to a similar location in the fingerprint. For example, the lookalike modeling service may use a projection function to project the entities of the candidate segment to a one-dimensional (1D) array, where the candidate segment fingerprints 235 are generated based on the projection. In this way, a segment fingerprint may indicate a distribution of entities within a segment based on similarities between features associated with entities within the segment.

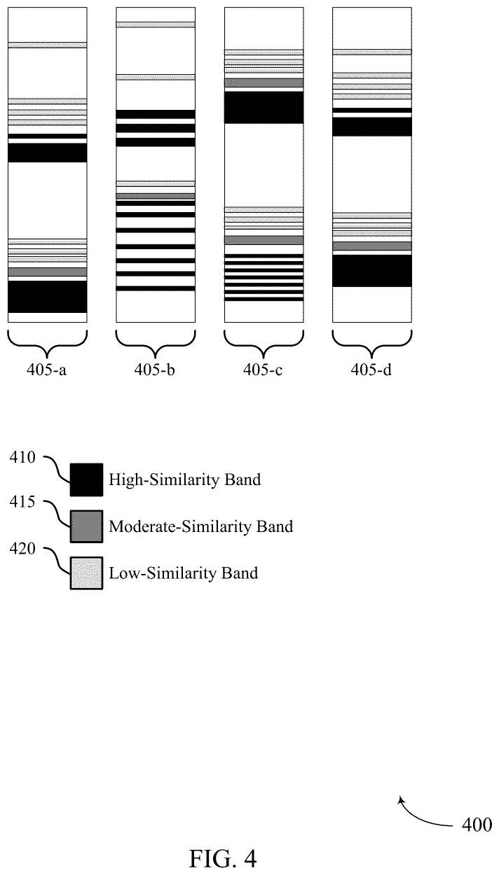

Each candidate segment fingerprint 235 may correspond to a candidate segment generated from the cluster models 230. For example, a candidate segment fingerprint 235-a (e.g., a fingerprint A) may correspond to a candidate segment output from the cluster model 230-a, a candidate segment fingerprint 235-b (e.g., a fingerprint B) may correspond to a candidate segment output from the cluster model 230-b, a candidate segment fingerprint 235-c (e.g., a fingerprint C) may correspond to a candidate segment output from the cluster model 230-c, and a candidate segment fingerprint 235-d (e.g., a fingerprint D) may correspond to a candidate segment output from the cluster model 230-d. In some examples, the candidate segment fingerprints 235 may be transformed into visual representations such that similarities between the candidate segments may be compared visually. The visual representation of the distribution of entities within the segment may be generated based on the projection of the entities of a candidate segment to a 1D array, where the visual representation may display the distribution based on the similarities between the features associated with the entities within the candidate segment. Techniques for generating the segment fingerprints are described herein with reference to FIG. 4.

In some cases, a set of similarity scores between the seed segment 215 and the set of candidate segments may be generated based on the seed segment fingerprint and the candidate segment fingerprints 235. After fingerprinting both the seed segment 215 and the set of candidate segments, the combinatorial modeling platform 210 may calculate a set of divergence scores between each candidate segment and the seed segment 215, where a divergence score measures how distinguishable each candidate segment is from the seed segment 215. For example, the divergence scores may be Jensen-Shannon divergence scores (derived from Kullback-Leibler-divergence), where D_{JS}(P∥Q)=½ D_{KL}(P∥M)+½ D_{KL} (M∥Q), where D_{KL}(P∥Q)=ΣᵢPᵢ·log₂Pᵢ/Qᵢ, and where M=½(P+Q). In such divergence calculations, D_{JS} may represent a Jensen-Shannon divergence score, D_{KL} may represent a Kullback-Leibler divergence score, P and Q may represent distributions (e.g., parameters), and D_{JS}(P∥Q) may be bounded by [0, log(2)]. A higher Jensen-Shannon divergence score may indicate that two fingerprints are more diverged (e.g., distinguished, different). In some examples, normalization may be applied to a divergence score. Other methods may be used to calculate divergence.

Typical methods for segment similarity may include calculating pair-wise U2U similarity with a particular aggregation function or a segment centroid as an approximation of the segment itself. The complexity of such similarity calculations may range from O(n) to O(n²) when each segment include n users. Simple algorithms for centroid calculations may provide unsatisfying results, particularly if segment users are widely distributed and diverse. Alternatively, more complex algorithms may be computationally expensive and may fail to guarantee convergence. The techniques for divergence score calculation described herein may outperform the U2U and centroid calculations by having a complexity O(p), where p. may represent a length of a segment fingerprint and is much smaller than n.

Based on the set of divergence scores for the set of candidate segments and the set of confidence scores generated for the entities of the set of candidate segments using the cluster models 230, the combinatorial modeling platform 210 may use a combinatorial model to generate a set of combinatorial scores for the entities of the set of candidate segments. For k candidate segments, m may represent a desired lookalike segment size for a candidate segment Cᵢ for {C₁, C₂, . . . , Cₖ}, where Cᵢ={{uᵢ₁, Sᵢ₁}, {uᵢ₂, sᵢ₂}, . . . , {uᵢᵣ, Sᵢₘ}} and {uᵢⱼ, Sᵢⱼ} may represent a user (Wᵢⱼ) j with an associated combinatorial score csᵢⱼ produced by a cluster model i. That is, a confidence score sᵢⱼ may indicate how similar a user uᵢⱼ is to a seed segment based on a cluster model 230 as described herein.

Using the confidence scores sᵢⱼ for each user uᵢⱼ and the set of divergence scores D_{JS}(i), the combinatorial modeling platform 210 may calculate a set of combinatorial scores csᵢⱼ for each user (entity) of a candidate segment by csᵢⱼ=Sᵢⱼ*(log(2)−D_{JS}(i)). A combinatorial score csᵢⱼ may calibrate the candidate segments such that they may be compared directly to each other for similarity scoring. In this way, a combinatorial score may be calculated based on the divergence score, thus representing a similarity between the candidate segment fingerprints 235 and the seed segment fingerprint. The candidate segments may be merged based on their combinatorial scores csᵢⱼ and confidence scores sᵢⱼ as S={{uᵢⱼ, csᵢⱼ}, i∈[1, k], j∈[1, m] }, where S may represent a total candidate segment based on merging the users in the sets of candidate segments using their combinatorial scores.

The combinatorial modeling platform 210 may use the combinatorial scores of each user to identify users that are similar to the seed segment. For users that exist in multiple candidate segments, a user's maximum combinatorial score may be used at its final score to determine its similarity. In some examples, the combinatorial modeling platform 210 may include combinatorial ranking function 240, which may rank S according to the combinatorial scores csᵢⱼ and identifying a top m users to belong to a lookalike segment 245 (e.g., a segment most similar to the seed segment). In this way, the combinatorial ranking function 240 may rank users (e.g., entities) of the set of candidate segments based on the set of similar scores and identify the lookalike segment 245 based on the ranking.

In addition to ranking the combinatorial scores of users to identify the lookalike segment 245, the combinatorial ranking function 240 may identify top factors (e.g., features, attributes) that contribute to each lookalike user. That is, the combinatorial ranking function 240 may identify one or more first features associated with the users of the candidate segments that have a higher contribution to respective similarity scores of the set of similarity scores relative to a contribution of one or more second features. For example, a purchase history feature indicating that a purchase of a particular product within the past thirty days may contribute more to a user's similarity score than a city in which the user who made the purchase is located. That is, two users who live in a same city but made different purchases may be less similar than two users who live in different cities but made the same purchase. Such insights may enable organizations to better understand in what aspect each user “looks” or behaves like users of the seed segment.

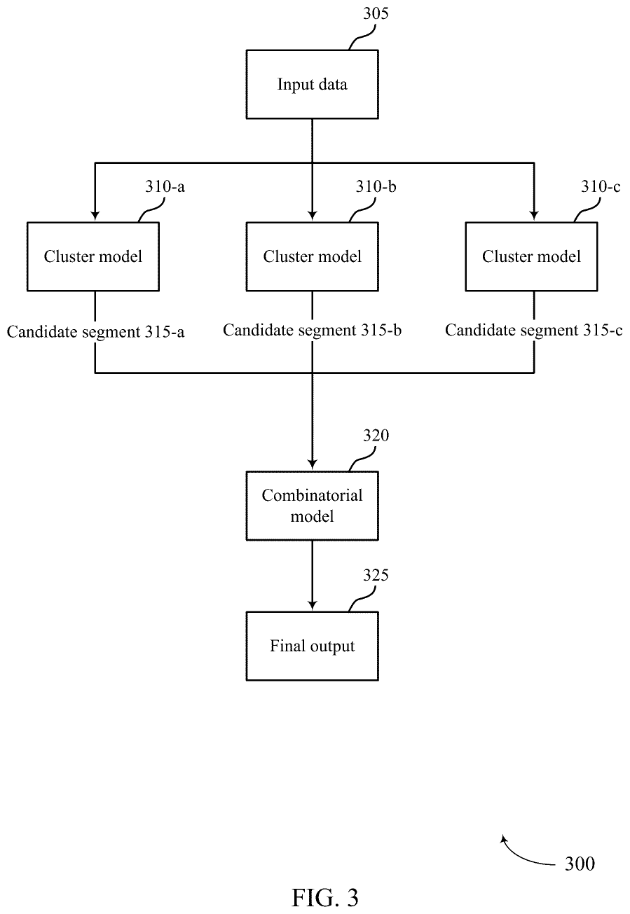

FIG. 3 illustrates an example of a two-layer model 300 that supports audience segment fingerprinting and similarity in accordance with aspects of the present disclosure. The two-layer model 300 may implement or be implemented by aspects of the data processing system 100 and the computing architecture 200. For example, the two-layer model 300 may depict a flow of information between a set of cluster models 310 and a combinatorial model 320, which may be used together to generate candidate segments and rank users of each candidate segment with respect to their similarity scores.

As described herein with reference to FIG. 2, a lookalike modeling service may utilize a two-laver model approach to generate audience (e.g., user, customer) segment fingerprints and identify a lookalike segment that corresponds to a seed segment. In some cases, input data 305 may be input to a set of cluster models 310. The input data 305 may include a corpus of entity data including data associated with features, attributes, and behaviors that correspond to entity identifiers (e.g., users). In some examples, the input data 305 may be input to the cluster models 310 such that each cluster model 310 may be associated with a particular feature type. For example, a cluster model 310-a may be associated with static profile-related features (e.g., demographic information), a cluster model 310-b may be associated with user product purchase history, and a cluster model 310-c may be associated with product affinities. In addition, each cluster model 310 may be a different model (e.g., a classification or regression model, an LSH model, etc.) suited for the feature type corresponding to that cluster model 310. In some examples, the cluster models 310 may support other feature types or models, and a same type of cluster model 310 may be used for two or more different feature types.

Each cluster model 310 may output a candidate segment 315. For example, the cluster model 310-a may output a candidate segment 315-a, the cluster model 310-b may output a candidate segment 315-b, and the cluster model 310-c may output a candidate segment 315-c. Each candidate segment 315 may correspond to a list of recommended lookalike users (e.g., users that may potentially be similar to a seed segment). Moreover, each user of a candidate segment 315 may be associated with a confidence score indicating how similar the user may be to the seed segment given the feature type associated with the corresponding cluster model 310.

Because each cluster model 310 is based on a different machine learning model and a different feature type, each cluster model 310 may use different scoring metrics for scoring similarities between users. To combine the candidate segments 315 and rank similarities between the candidate segments 315 and a seed segment in a meaningful way despite the differing scoring metrics, the combinatorial model 320 may use divergence scoring and the confidence scores to merge the candidate segments and generate combinatorial scores for each user of the candidate segments 315. The combinatorial scores may be used to rank the users of the candidate segments 315 in terms of similarities, and the combinatorial model 320 may identify some quantity of most-similar (e.g., highest ranking) users into a lookalike segment, which may be a final output 325 of the combinatorial model 320.

FIG. 4 illustrates an example of segment fingerprints 400 that support audience segment fingerprinting and similarity in accordance with aspects of the present disclosure. The segment fingerprints 400 may implement or be implemented by aspects of the data processing system 100 and the computing architecture 200. For example, the segment fingerprints 400 may include segment fingerprints 405-a, 405-b, 405-c, and 405-d (e.g., candidate segment fingerprints), which may be generated based on a set of segments using a set of cluster models and respective sets of features associated with entities of the set of segments.

As described herein with reference to FIG. 2, the segment fingerprints 405 corresponding to a set of segments (e.g., candidate segments) may be generated and compared to show similarities between users of the set of segments. The users may be ranked according to their similarities, and some quantity of most similar (e.g., highest ranking) users may make up a segment of lookalike entities (e.g., a segment of users that are most similar to the seed segment).

The segment fingerprints 405 may be generated based on an LSH function, a segment of n users, and a set of feature vectors, v={v₁, v₂, . . . , Vₙ}, where vᵢ∈Rⁿ. A feature vector may include all features or attributes associated with a user or some features associated with a segment and a corresponding cluster model, and the n entities of the segment may be associated with respective feature vectors. In some examples, a segment fingerprinting model may generate a vector a for projecting a segment to a 1D array based on entities of the segment and the set of feature vectors. For example, the d-dimensional vector may be α=(x₁, x₂, . . . , X_{d}), where x, may follow a p-stable distribution

$$g ( x ) = \frac{1}{π ( 1 + {x}^{2} )} .$$

For a d-dimensional feature vector v, a dot product of α·v=Σᵢxᵢvᵢ may follow the same distribution as ∥v∥ₚα. In this way, users that have similar feature vectors may be projected to similar positions of a segment fingerprint 405.

Based on the vector and a projection function h(v), a model may generate a projected vector corresponding to the segment. For example, for a selected quantity ω and β∈[0, ω], the projection function

$$h ( v ) = ⌊ \frac{α \cdot v + β}{ω} ⌋$$

may be used to project a segment to a 1D array of a given length. Due to properties of the p-stable distribution, h(v) may project feature vectors that are more similar to each other to closer buckets, where each bucket may include a set of users from a candidate segment. As such, h(v) may be used to transform each feature vector in a segment. Based on the projected vector, the model may generate a segment fingerprint 405 for a given segment. The segment fingerprint 405 may indicate a distribution of the users within the segment based on similarities between respective sets of features associated with the entities of the segment. In some examples, a normalization function may be applied to the projected vector based on zero padding such that each segment fingerprint 405 has a same length, which may allow the segment fingerprints 405 to be compared directly. The normalization function may be represented as F (segment)=norm({h(\hat{v}): R^{d}→N}). That is, the model may normalize the projected vector based on a zero-padding function, where a segment fingerprint 405 is generated based on the normalized projected vector. It should be noted that the segment fingerprinting as described herein may be performed for any quantity of segments of a set of segments generated by a set of cluster models.

In some examples, a visual representation may be generated for each segment fingerprint 405, where the visual representation may display the distribution of entities within the segment using different colored bands. High-similarity bands 410 (e.g., black regions) may indicate relatively high similarity between users of the segment, moderate-similarity bands 415 (e.g., dark gray regions) may indicate moderate similarity between users of the segment, and low-similarity bands 420 may indicate relatively low similarity between users of the segment. For example, as users are depicted in a segment fingerprint 405 based on features, the high-similarity bands 410 indicate that many users share a given fingerprint in that segment. In this way, users are grouped across the segment fingerprints 405 based on their respective features.

Moreover, the more high-similarity bands 410 a segment fingerprint 405 includes, the more unique the segment may be. The more spread out the bands in a segment fingerprint 405 (e.g., the higher quantity of smaller high, moderate, or low similarity bands the segment fingerprint 405 includes), the more common the segment be to a common user. For example, the segment fingerprint 405-a may be more unique than the segment fingerprint 405-b as the segment fingerprint 405-a includes wide high-similarity bands 410 as compared to the segment fingerprint 405-b, which includes many high, moderate, and low-similarity bands that are relatively smaller and more spread out. Put another way, the segment fingerprint 405-a may correspond to a diverse segment of users that mostly identify with one of two groups, where the segment fingerprint 405-b may correspond to a more common segment of users who identify across many different groups. In some cases, a same user may be located in different locations in different segment fingerprints 405.

In some cases, an administrative user (e.g., a marketer) may use the segment fingerprints 405 and a seed segment fingerprint to calculate a set of similarity scores between the seed segment and the set of segments. For example, as described herein with reference to FIG. 2, a combinatorial model may calculate different scores for each segment fingerprint 405, merge the segments, and rank users of the segments based on their similarity scores to identify a lookalike segment of most-similar (e.g., highest-ranking) users.

Additionally, the visual representations of the segment fingerprints 405 may enable administrative users to visually distinguish segments based on their degrees of similarity. In some examples, this may apply to representing a groups or populations on a spectrum to compare how similar they are to each other. For example, segment fingerprints 405 may allow for a visual comparison between similar attributes of users located in different states, such that a user may see visually how different or similar population characteristics of different states may be to a population at large.

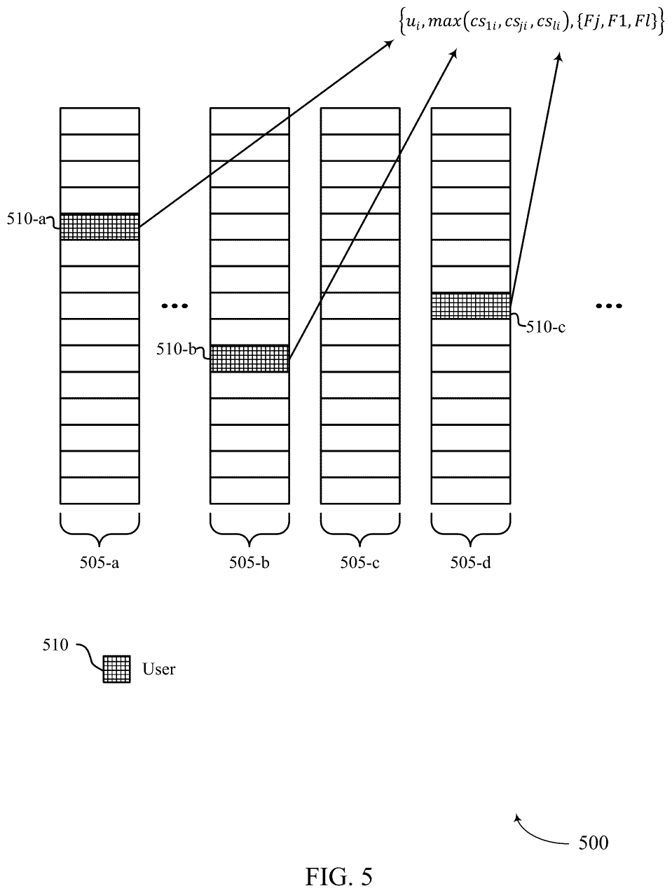

FIG. 5 illustrates an example of a combinatorial model 500 that supports audience segment fingerprinting and similarity in accordance with aspects of the present disclosure. The combinatorial model 500 may implement or be implemented by aspects of the data processing system 100 and the computing architecture 200. For example, the combinatorial model 500 may merge candidate segments 505 according to combinatorial scores and confidence scores for candidate segments 505, such that users of the candidate segments 505 may be ranked by similarity score.

A combinatorial model may be used to merge the candidate segments 505 (generated using a set of cluster models) to compare similarities between the candidate segments 505 (e.g., Cᵢ). For example, a combinatorial model may merge a set of candidate segments including a candidate segment 505-a (e.g., Cᵢ), a candidate segment 505-b (e.g., Cⱼ), a candidate segment 505-c (e.g., Cₕ), and a candidate segment 505-d (e.g., Cₗ), among any other candidate segments 505 (e.g., Cᵢ). Each candidate segment 505 may include a quantity of users 510 (e.g., uᵢⱼ), which each may correspond to a similarity score sᵢⱼ. As such, each user 510 as shown with reference to FIG. 5 may correspond to a user-similarity score pair, similarity score {uᵢ, csⱼᵢ}.

As described with reference to FIG. 2, a divergence score D_{JS} may be calculated for each candidate segment 505. The combinatorial model may calculate a combinatorial score csᵢⱼ for each user 510 associated with a user similarity score sᵢⱼ (e.g., a confidence score) produced by a cluster model i. To do so, the combinatorial model may calculate a weighted union of each candidate segment 505 for each user similarity score multiplied by a segment similarity score, (log(2)−D_{JS}(i)). In some examples, the candidate segments 505 may be merged using the combinatorial scores and using the merged segment. Users 510 in the candidate segments may be ranked accordingly to their similarity scores such that most-similar (e.g., highest-ranking) users 510 may be identified for a segment of lookalike users.

The different candidate segments 505 may depict where a same user 510 ranks compared to other users 510 in each candidate segment 505 based on their respective similarity scores. The users 510 in each candidate segment 505 may be ranked in descending order of similarity (from most similar to least similar). For example, a user 510-a of the candidate segment 505-a may correspond to a user-combinatorial score pair {uᵢ, cs₁ᵢ} and may rank 5th highest in terms of similarity with a seed segment. Alternatively, a user 510-b of the candidate segment 505-b may correspond to a user-combinatorial score pair {uᵢ, csⱼᵢ} and may only rank 10th highest. In some cases, the user 510 may be excluded from the candidate segment 505-c. Additionally, a user 510-c of the candidate segment 505-d may correspond to a user-combinatorial score pair {uᵢ, csₗᵢ} and may rank 8th highest. It should be noted that the user 510-a, the user 510-b, and the user 510-c are the same user 510 that belongs to multiple candidate segments 505.

In some examples, the combinatorial model may merge (e.g., combine) the candidate segments 505 and their combinatorial scores and utilize the maximum combinatorial score from each candidate segment 505 to identify the lookalike segment. The combined score may be {uᵢ, max (cs₁ᵢ, csⱼᵢ, csₗᵢ), {Fⱼ, F₁, Fₗ} }, where Fᵢ may correspond to a feature. As such, if a user 510 is similar to the seed segment based on multiple feature types, for example geographic information and product affinity data, then the similarity may be greater than for users 510 that are similar to the seed segment in terms of a single feature type. As such, the combinatorial model may indicate what factors may contribute to a user's rank in a candidate segment 505.

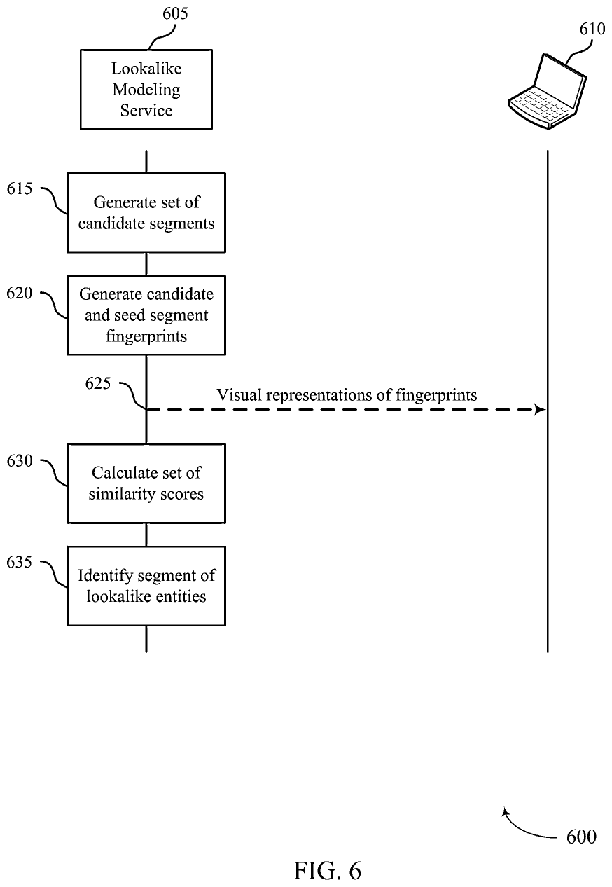

FIG. 6 illustrates an example of a process flow 600 that supports audience segment fingerprinting and similarity in accordance with aspects of the present disclosure. The process flow 600 may implement or be implemented by aspects of the data processing system 100 or the computing architecture 200. For example, the process flow 600 may include a lookalike modeling service 605 and a user device 610, which may be examples of corresponding services and platforms described herein. In the following description of the process flow 600, operations between the lookalike modeling service 605 and the user device 610 be performed in a different order or at a different time than as shown. Additionally, or alternatively, some operations may be omitted from the process flow 600, and other operations may be added to the process flow 600. The process flow 600 may support techniques for generating audience segment fingerprints and performing automatic lookalike (e.g., similarity) discovery.

At 615, the lookalike modeling service 605 may generate, using a set of cluster models and based on a seed segment and a corpus of entity data, a set of candidate segments, where a candidate segment of the set of candidate segments includes a set of multiple entity identifiers from the corpus of entity data. A cluster model may be a particular machine learning model (e.g., LSH model, classification model, etc.) based on a feature type. That is, each candidate segment may be generated based on particular features (e.g., user attributes or behaviors, such as demographic information, product affinities, purchase history, etc.).

At 620, the lookalike modeling service 605 may generate, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment. That is, feature vectors associated with each candidate segment may be projected to a segment fingerprint to show users that share similar features.

At 625, the lookalike modeling service 605 may generate visual representations of each segment fingerprint such that similarities between users may be compared visually, and the visual representations may be displayed at the user device 610. The visual representations may show features shared by many users using dark-colored bands and features shared by relatively fewer users using lighter-colored bands.

At 630, the lookalike modeling service 605 may calculate a set of similarity scores between the seed segment and the set of candidate segments based on the seed segment fingerprint and the set of candidate segment fingerprints. In some examples, the similarity scores may be calculated based on a set of divergence scores and a set of combinatorial scores, which are merged to allow for similarity comparisons between different candidate segments. A similarity score may indicate how similar a candidate segment or a user is to a seed segment.

At 635, the lookalike modeling service 605 may identify, from the set of candidate segments and based on the set of similarity scores, a segment of lookalike entities corresponding to the seed segment. For example, the users in the set of candidate segments may be ranked in terms of similarity, and some quantity of users that are ranked highest (e.g., most similar to the seed segment) may be identified for inclusion in the segment of lookalike entities.

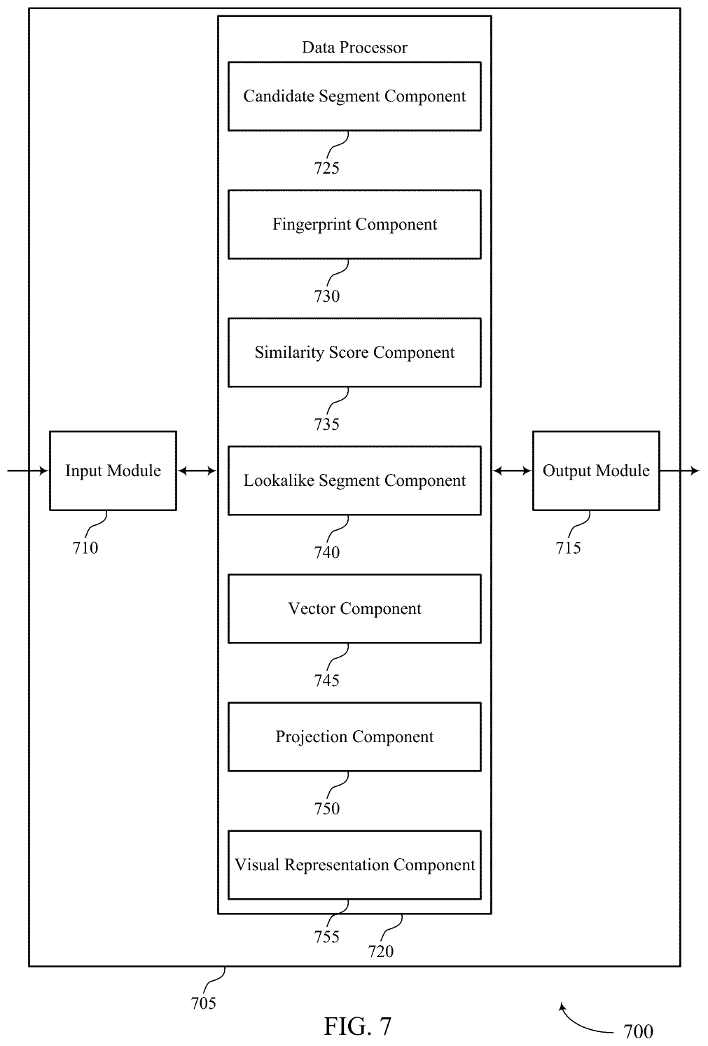

FIG. 7 illustrates a block diagram 700 of a device 705 that supports audience segment fingerprinting and similarity in accordance with aspects of the present disclosure. The device 705 may include an input module 710, an output module 715, and a data processor 720. The device 705 may also include a processor. Each of these components may be in communication with one another (e.g., via one or more buses).

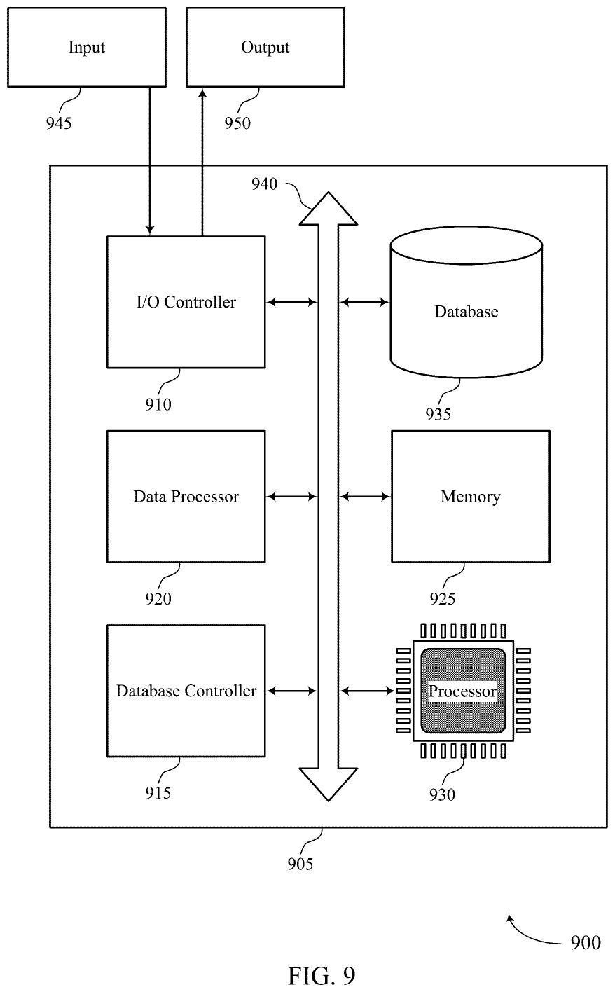

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the data processor 720 to support audience segment fingerprinting and similarity. In some cases, the input module 710 may be a component of an I/O controller 910 as described with reference to FIG. 9.

The output module 715 may manage output signals for the device 705. For example, the output module 715 may receive signals from other components of the device 705, such as the data processor 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the data processor 720 may include a candidate segment component 725, a fingerprint component 730, a similarity score component 735, a lookalike segment component 740, a vector component 745, a projection component 750, a visual representation component 755, or any combination thereof. In some examples, the data processor 720, or various components thereof, may be configured to perform various operations (e.g., receiving, monitoring, transmitting) using or otherwise in cooperation with the input module 710, the output module 715, or both. For example, the data processor 720 may receive information from the input module 710, send information to the output module 715, or be integrated in combination with the input module 710, the output module 715, or both to receive information, transmit information, or perform various other operations as described herein.

The data processor 720 may support data processing in accordance with examples as disclosed herein. The candidate segment component 725 may be configured to support generating, using a set of cluster models and based on a seed segment and a corpus of entity data, a set of candidate segments, where a candidate segment of the set of candidate segments includes a set of multiple entity identifiers from the corpus of entity data. The fingerprint component 730 may be configured to support generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment. The similarity score component 735 may be configured to support calculating a set of similarity scores between the seed segment and the set of candidate segments based on the seed segment fingerprint and the set of candidate segment fingerprints. The lookalike segment component 740 may be configured to support identifying, from the set of candidate segments and based on the set of similarity scores, a segment of lookalike entities corresponding to the seed segment.

Additionally, or alternatively, the data processor 720 may support data processing in accordance with examples as disclosed herein. The vector component 745 may be configured to support generating a vector for projecting a first segment of a set of segments to a one-dimensional array based on entities of the first segment and a set of feature vectors, where the entities of the first segment are associated with respective feature vectors. The projection component 750 may be configured to support generating, based on the vector and a projection function, a projected vector corresponding to the first segment. The fingerprint component 730 may be configured to support generating, based on the projected vector, a first segment fingerprint indicative of a distribution of the entities within the first segment based on similarities between respective sets of features associated with the entities of the first segment. The visual representation component 755 may be configured to support generating, based on the first segment fingerprint and a seed segment fingerprint, a visual representation of the first segment fingerprint that displays the distribution of the entities within the first segment.

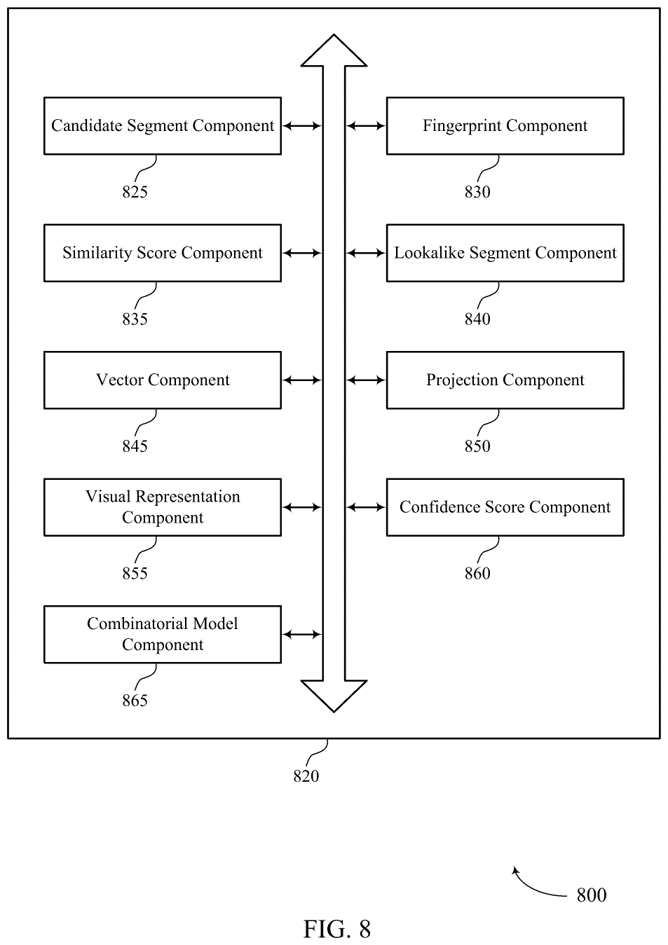

FIG. 8 illustrates a block diagram 800 of a data processor 820 that supports audience segment fingerprinting and similarity in accordance with aspects of the present disclosure. The data processor 820 may be an example of aspects of a data processor or a data processor 720, or both, as described herein. The data processor 820, or various components thereof, may be an example of means for performing various aspects of audience segment fingerprinting and similarity as described herein. For example, the data processor 820 may include a candidate segment component 825, a fingerprint component 830, a similarity score component 835, a lookalike segment component 840, a vector component 845, a projection component 850, a visual representation component 855, a confidence score component 860, a combinatorial model component 865, or any combination thereof. Each of these components may communicate, directly or indirectly, with one another (e.g., via one or more buses).

The data processor 820 may support data processing in accordance with examples as disclosed herein. The candidate segment component 825 may be configured to support generating, using a set of cluster models and based on a seed segment and a corpus of entity data, a set of candidate segments, where a candidate segment of the set of candidate segments includes a set of multiple entity identifiers from the corpus of entity data. The fingerprint component 830 may be configured to support generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment. The similarity score component 835 may be configured to support calculating a set of similarity scores between the seed segment and the set of candidate segments based on the seed segment fingerprint and the set of candidate segment fingerprints. The lookalike segment component 840 may be configured to support identifying, from the set of candidate segments and based on the set of similarity scores, a segment of lookalike entities corresponding to the seed segment.

In some examples, to support generating the set of candidate segments, the confidence score component 860 may be configured to support generating, using the set of cluster models, a set of confidence scores for the entities of the set of candidate segments, a confidence score of the set of confidence scores indicative of a probability of entity classification into a respective candidate segment of the set of candidate segments. In some examples, a cluster model of the set of cluster models corresponds to a type of feature associated with the entities of the set of candidate segments.

In some examples, to support generating the set of candidate segment fingerprints and the seed segment fingerprint, the fingerprint component 830 may be configured to support projecting, using a projection function, the entities of the candidate segment to a one-dimensional array, where the set of candidate segment fingerprints are generated based on the projection.

In some examples, to support generating the set of candidate segment fingerprints and the seed segment fingerprint, the fingerprint component 830 may be configured to support generating, based on a projection of the entities of the candidate segment to a one-dimensional array, a visual representation of the distribution of entities within the candidate segment, the distribution of entities based on the similarities between the features associated with the entities within the candidate segment.

In some examples, to support calculating the set of similarity scores between the seed segment and the set of candidate segments, the combinatorial model component 865 may be configured to support calculating, based on the set of candidate segment fingerprints and the seed segment fingerprint, a set of divergence scores between the seed segment and the set of candidate segments. In some examples, to support calculating the set of similarity scores between the seed segment and the set of candidate segments, the combinatorial model component 865 may be configured to support calculating, based on the set of divergence scores and a set of confidence scores generated for the entities of the set of candidate segments using the set of cluster models, a set of combinatorial scores for the entities of the set of candidate segments. In some examples, to support calculating the set of similarity scores between the seed segment and the set of candidate segments, the combinatorial model component 865 may be configured to support calculating, based on the set of combinatorial scores for the entities of the set of candidate segments, the set of similarity scores.

In some examples, to support calculating the set of combinatorial scores, the combinatorial model component 865 may be configured to support identifying one or more first features associated with the entities of the set of candidate segments that have higher contribution to respective similarity scores of the set of similarity scores relative to a contribution of one or more second features.

In some examples, to support identifying the segment of lookalike entities, the lookalike segment component 840 may be configured to support ranking entities the set of candidate segments based on the set of similarity scores. In some examples, to support identifying the segment of lookalike entities, the lookalike segment component 840 may be configured to support identifying the segment of lookalike entities based on the ranking.

Additionally, or alternatively, the data processor 820 may support data processing in accordance with examples as disclosed herein. The vector component 845 may be configured to support generating a vector for projecting a first segment of a set of segments to a one-dimensional array based on entities of the first segment and a set of feature vectors, where the entities of the first segment are associated with respective feature vectors. The projection component 850 may be configured to support generating, based on the vector and a projection function, a projected vector corresponding to the first segment. In some examples, the fingerprint component 830 may be configured to support generating, based on the projected vector, a first segment fingerprint indicative of a distribution of the entities within the first segment based on similarities between respective sets of features associated with the entities of the first segment. The visual representation component 855 may be configured to support generating, based on the first segment fingerprint and a seed segment fingerprint, a visual representation of the first segment fingerprint that displays the distribution of the entities within the first segment.

In some examples, the projection component 850 may be configured to support normalizing the projected vector based on a zero-padding function, where the first segment fingerprint generated based on the normalized projected vector.

In some examples, the similarity score component 835 may be configured to support calculating a set of similarity scores between the seed segment and the first segment based on the seed segment fingerprint and the first segment fingerprint.

In some examples, the visual representation component 855 may be configured to support identifying similarities between the seed segment and the first segment based on the visual representation of the first segment fingerprint.

In some examples, the projection component 850 may be configured to support generating, based on a set of vectors for projecting respective segments of the set of segments to respective one-dimensional arrays and the projection function, a set of projected vectors corresponding to the set of segments. In some examples, the fingerprint component 830 may be configured to support generating, based on the set of projected vectors, a set of segment fingerprints based on similarities between respective sets of features associated with entities of the set of segments and the sets of features associated with the entities of the seed segment. In some examples, the visual representation component 855 may be configured to support generating, based on the set of segment fingerprints and the seed segment fingerprint, a set of visual representations of the set of segment fingerprints that display the distribution of the entities within a respective segment.

In some examples, a dark band of the visual representation indicates a high similarity between the entities within the first segment. In some examples, a light band of the visual representation indicates a low similarity between the entities within the first segment.

FIG. 9 illustrates a diagram of a system 900 including a device 905 that supports audience segment fingerprinting and similarity in accordance with aspects of the present disclosure. The device 905 may be an example of or include the components of a device 705 as described herein. The device 905 may include components for bi-directional data communications including components for transmitting and receiving communications, such as a data processor 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and ROM. The memory 925 may store computer-readable, computer-executable software including instructions that, when executed, cause the processor 930 to perform various functions described herein. In some cases, the memory 925 may contain, among other things, a BIOS which may control basic hardware or software operation such as the interaction with peripheral components or devices.

The processor 930 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting audience segment fingerprinting and similarity).

The data processor 920 may support data processing in accordance with examples as disclosed herein. For example, the data processor 920 may be configured to support generating, using a set of cluster models and based on a seed segment and a corpus of entity data, a set of candidate segments, where a candidate segment of the set of candidate segments includes a set of multiple entity identifiers from the corpus of entity data. The data processor 920 may be configured to support generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment. The data processor 920 may be configured to support calculating a set of similarity scores between the seed segment and the set of candidate segments based on the seed segment fingerprint and the set of candidate segment fingerprints. The data processor 920 may be configured to support identifying, from the set of candidate segments and based on the set of similarity scores, a segment of lookalike entities corresponding to the seed segment.

Additionally, or alternatively, the data processor 920 may support data processing in accordance with examples as disclosed herein. For example, the data processor 920 may be configured to support generating a vector for projecting a first segment of a set of segments to a one-dimensional array based on entities of the first segment and a set of feature vectors, where the entities of the first segment are associated with respective feature vectors. The data processor 920 may be configured to support generating, based on the vector and a projection function, a projected vector corresponding to the first segment. The data processor 920 may be configured to support generating, based on the projected vector, a first segment fingerprint indicative of a distribution of the entities within the first segment based on similarities between respective sets of features associated with the entities of the first segment. The data processor 920 may be configured to support generating, based on the first segment fingerprint and a seed segment fingerprint, a visual representation of the first segment fingerprint that displays the distribution of the entities within the first segment.

By including or configuring the data processor 920 in accordance with examples as described herein, the device 905 may support techniques for audience segment fingerprinting and similarity scoring, which may improve accessibility to similarity scoring, the performance of similarity scoring at scale, and computational efficiency.

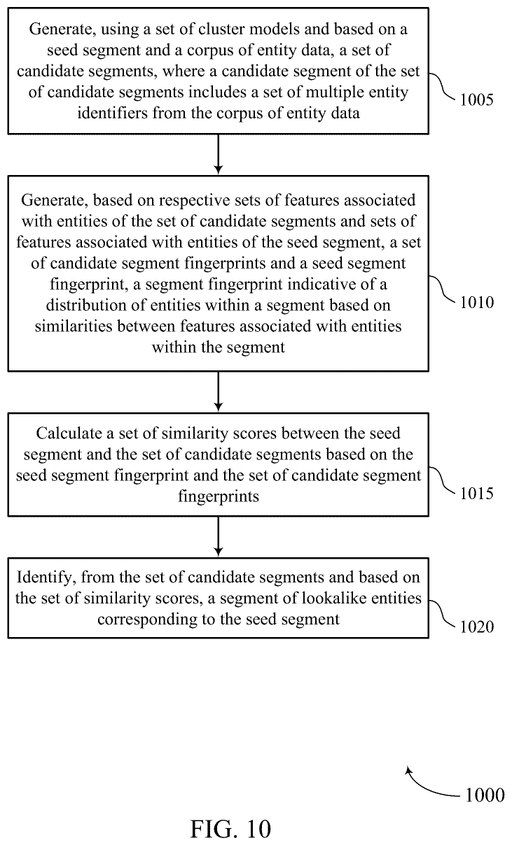

FIG. 10 illustrates a flowchart showing a method 1000 that supports audience segment fingerprinting and similarity in accordance with aspects of the present disclosure. The operations of the method 1000 may be implemented by a data processor or its components as described herein. For example, the operations of the method 1000 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1005, the method may include generating, using a set of cluster models and based on a seed segment and a corpus of entity data, a set of candidate segments, where a candidate segment of the set of candidate segments includes a set of multiple entity identifiers from the corpus of entity data. The operations of 1005 may be performed in accordance with examples as disclosed herein. In some examples, aspects of the operations of 1005 may be performed by a candidate segment component 825 as described with reference to FIG. 8.

At 1010, the method may include generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment. The operations of 1010 may be performed in accordance with examples as disclosed herein. In some examples, aspects of the operations of 1010 may be performed by a fingerprint component 830 as described with reference to FIG. 8.

At 1015, the method may include calculating a set of similarity scores between the seed segment and the set of candidate segments based on the seed segment fingerprint and the set of candidate segment fingerprints. The operations of 1015 may be performed in accordance with examples as disclosed herein. In some examples, aspects of the operations of 1015 may be performed by a similarity score component 835 as described with reference to FIG. 8.

At 1020, the method may include identifying, from the set of candidate segments and based on the set of similarity scores, a segment of lookalike entities corresponding to the seed segment. The operations of 1020 may be performed in accordance with examples as disclosed herein. In some examples, aspects of the operations of 1020 may be performed by a lookalike segment component 840 as described with reference to FIG. 8.

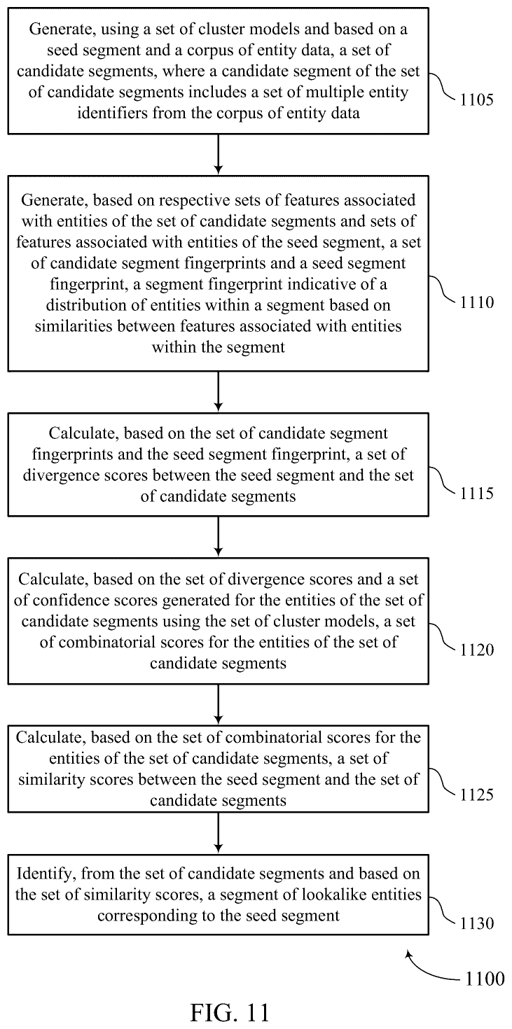

FIG. 11 illustrates a flowchart showing a method 1100 that supports audience segment fingerprinting and similarity in accordance with aspects of the present disclosure. The operations of the method 1100 may be implemented by a data processor or its components as described herein. For example, the operations of the method 1100 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1105, the method may include generating, using a set of cluster models and based on a seed segment and a corpus of entity data, a set of candidate segments, where a candidate segment of the set of candidate segments includes a set of multiple entity identifiers from the corpus of entity data. The operations of 1105 may be performed in accordance with examples as disclosed herein. In some examples, aspects of the operations of 1105 may be performed by a candidate segment component 825 as described with reference to FIG. 8.

At 1110, the method may include generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment. The operations of 1110 may be performed in accordance with examples as disclosed herein. In some examples, aspects of the operations of 1110 may be performed by a fingerprint component 830 as described with reference to FIG. 8.

At 1115, the method may include calculating, based on the set of candidate segment fingerprints and the seed segment fingerprint, a set of divergence scores between the seed segment and the set of candidate segments. The operations of 1115 may be performed in accordance with examples as disclosed herein. In some examples, aspects of the operations of 1115 may be performed by a combinatorial model component 865 as described with reference to FIG. 8.

At 1120, the method may include calculating, based on the set of divergence scores and a set of confidence scores generated for the entities of the set of candidate segments using the set of cluster models, a set of combinatorial scores for the entities of the set of candidate segments. The operations of 1120 may be performed in accordance with examples as disclosed herein. In some examples, aspects of the operations of 1120 may be performed by a combinatorial model component 865 as described with reference to FIG. 8.

At 1125, the method may include calculating, based on the set of combinatorial scores for the entities of the set of candidate segments, a set of similarity scores between the seed segment and the set of candidate segments. The operations of 1125 may be performed in accordance with examples as disclosed herein. In some examples, aspects of the operations of 1125 may be performed by a combinatorial model component 865 as described with reference to FIG. 8.

At 1130, the method may include identifying, from the set of candidate segments and based on the set of similarity scores, a segment of lookalike entities corresponding to the seed segment. The operations of 1130 may be performed in accordance with examples as disclosed herein. In some examples, aspects of the operations of 1135 may be performed by a lookalike segment component 840 as described with reference to FIG. 8.

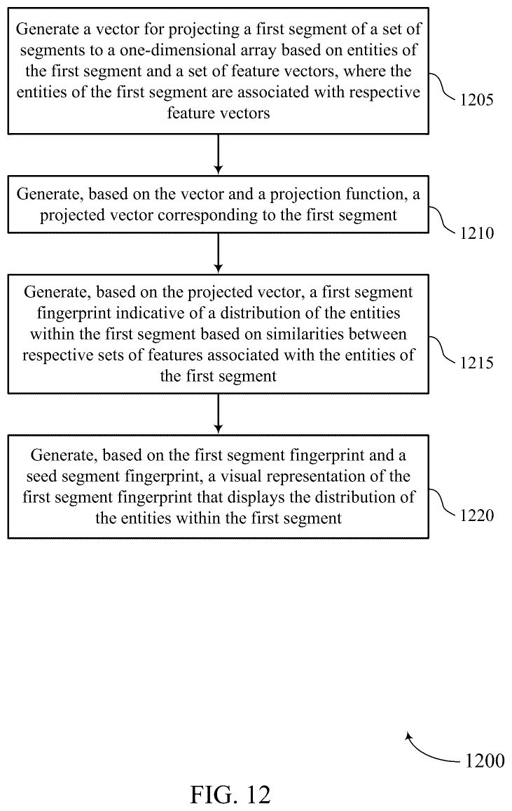

FIG. 12 illustrates a flowchart showing a method 1200 that supports audience segment fingerprinting and similarity in accordance with aspects of the present disclosure.

The operations of the method 1200 may be implemented by a data processor or its components as described herein. For example, the operations of the method 1200 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1205, the method may include generating a vector for projecting a first segment of a set of segments to a one-dimensional array based on entities of the first segment and a set of feature vectors, where the entities of the first segment are associated with respective feature vectors. The operations of 1205 may be performed in accordance with examples as disclosed herein. In some examples, aspects of the operations of 1205 may be performed by a vector component 845 as described with reference to FIG. 8.

At 1210, the method may include generating, based on the vector and a projection function, a projected vector corresponding to the first segment. The operations of 1210 may be performed in accordance with examples as disclosed herein. In some examples, aspects of the operations of 1210 may be performed by a projection component 850 as described with reference to FIG. 8.

At 1215, the method may include generating, based on the projected vector, a first segment fingerprint indicative of a distribution of the entities within the first segment based on similarities between respective sets of features associated with the entities of the first segment. The operations of 1215 may be performed in accordance with examples as disclosed herein. In some examples, aspects of the operations of 1215 may be performed by a fingerprint component 830 as described with reference to FIG. 8.

At 1220, the method may include generating, based on the first segment fingerprint and a seed segment fingerprint, a visual representation of the first segment fingerprint that displays the distribution of the entities within the first segment. The operations of 1220 may be performed in accordance with examples as disclosed herein. In some examples, aspects of the operations of 1220 may be performed by a visual representation component 855 as described with reference to FIG. 8.

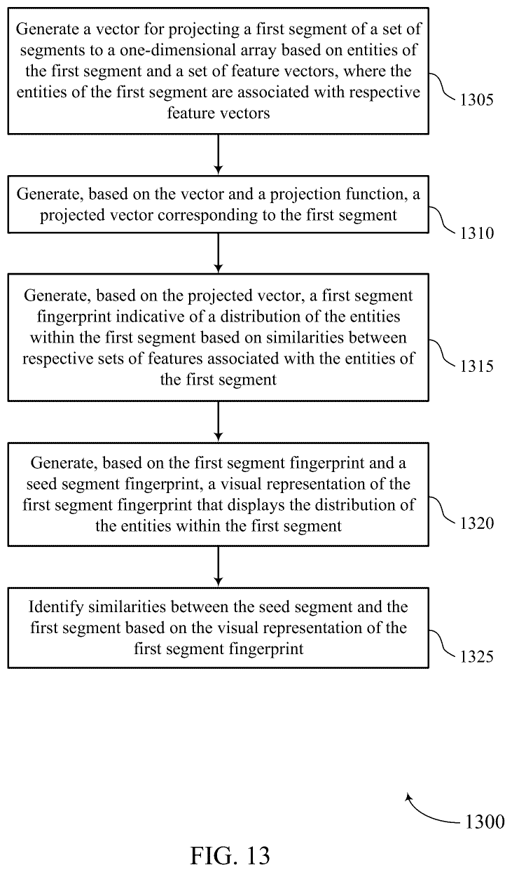

FIG. 13 illustrates a flowchart showing a method 1300 that supports audience segment fingerprinting and similarity in accordance with aspects of the present disclosure. The operations of the method 1300 may be implemented by a data processor or its components as described herein. For example, the operations of the method 1300 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1305, the method may include generating a vector for projecting a first segment of a set of segments to a one-dimensional array based on entities of the first segment and a set of feature vectors, where the entities of the first segment are associated with respective feature vectors. The operations of 1305 may be performed in accordance with examples as disclosed herein. In some examples, aspects of the operations of 1305 may be performed by a vector component 845 as described with reference to FIG. 8.

At 1310, the method may include generating, based on the vector and a projection function, a projected vector corresponding to the first segment. The operations of 1310 may be performed in accordance with examples as disclosed herein. In some examples, aspects of the operations of 1310 may be performed by a projection component 850 as described with reference to FIG. 8.

At 1315, the method may include generating, based on the projected vector, a first segment fingerprint indicative of a distribution of the entities within the first segment based on similarities between respective sets of features associated with the entities of the first segment. The operations of 1315 may be performed in accordance with examples as disclosed herein. In some examples, aspects of the operations of 1315 may be performed by a fingerprint component 830 as described with reference to FIG. 8.

At 1320, the method may include generating, based on the first segment fingerprint and a seed segment fingerprint, a visual representation of the first segment fingerprint that displays the distribution of the entities within the first segment. The operations of 1320 may be performed in accordance with examples as disclosed herein. In some examples, aspects of the operations of 1320 may be performed by a visual representation component 855 as described with reference to FIG. 8.

At 1325, the method may include identifying similarities between the seed segment and the first segment based on the visual representation of the first segment fingerprint. The operations of 1325 may be performed in accordance with examples as disclosed herein. In some examples, aspects of the operations of 1325 may be performed by a visual representation component 855 as described with reference to FIG. 8.

A method for data processing is described. The method may include generating, using a set of cluster models and based on a seed segment and a corpus of entity data, a set of candidate segments, where a candidate segment of the set of candidate segments includes a set of multiple entity identifiers from the corpus of entity data, generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment, calculating a set of similarity scores between the seed segment and the set of candidate segments based on the seed segment fingerprint and the set of candidate segment fingerprints, and identifying, from the set of candidate segments and based on the set of similarity scores, a segment of lookalike entities corresponding to the seed segment.

An apparatus for data processing is described. The apparatus may include a processor, memory coupled with the processor, and instructions stored in the memory. The instructions may be executable by the processor to cause the apparatus to generate, using a set of cluster models and based on a seed segment and a corpus of entity data, a set of candidate segments, where a candidate segment of the set of candidate segments includes a set of multiple entity identifiers from the corpus of entity data, generate, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment, calculate a set of similarity scores between the seed segment and the set of candidate segments based on the seed segment fingerprint and the set of candidate segment fingerprints, and identify, from the set of candidate segments and based on the set of similarity scores, a segment of lookalike entities corresponding to the seed segment.

Another apparatus for data processing is described. The apparatus may include means for generating, using a set of cluster models and based on a seed segment and a corpus of entity data, a set of candidate segments, where a candidate segment of the set of candidate segments includes a set of multiple entity identifiers from the corpus of entity data, means for generating, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment, means for calculating a set of similarity scores between the seed segment and the set of candidate segments based on the seed segment fingerprint and the set of candidate segment fingerprints, and means for identifying, from the set of candidate segments and based on the set of similarity scores, a segment of lookalike entities corresponding to the seed segment.

A non-transitory computer-readable medium storing code for data processing is described. The code may include instructions executable by a processor to generate, using a set of cluster models and based on a seed segment and a corpus of entity data, a set of candidate segments, where a candidate segment of the set of candidate segments includes a set of multiple entity identifiers from the corpus of entity data, generate, based on respective sets of features associated with entities of the set of candidate segments and sets of features associated with entities of the seed segment, a set of candidate segment fingerprints and a seed segment fingerprint, a segment fingerprint indicative of a distribution of entities within a segment based on similarities between features associated with entities within the segment, calculate a set of similarity scores between the seed segment and the set of candidate segments based on the seed segment fingerprint and the set of candidate segment fingerprints, and identify, from the set of candidate segments and based on the set of similarity scores, a segment of lookalike entities corresponding to the seed segment.

In some examples of the method, apparatuses, and non-transitory computer-readable medium described herein, generating the set of candidate segments may include operations, features, means, or instructions for generating, using the set of cluster models, a set of confidence scores for the entities of the set of candidate segments, a confidence score of the set of confidence scores indicative of a probability of entity classification into a respective candidate segment of the set of candidate segments.

In some examples of the method, apparatuses, and non-transitory computer-readable medium described herein, a cluster model of the set of cluster models corresponds to a type of feature associated with the entities of the set of candidate segments.

In some examples of the method, apparatuses, and non-transitory computer-readable medium described herein, generating the set of candidate segment fingerprints and the seed segment fingerprint may include operations, features, means, or instructions for projecting, using a projection function, the entities of the candidate segment to a one-dimensional array, where the set of candidate segment fingerprints may be generated based on the projection.

In some examples of the method, apparatuses, and non-transitory computer-readable medium described herein, generating the set of candidate segment fingerprints and the seed segment fingerprint may include operations, features, means, or instructions for generating, based on a projection of the entities of the candidate segment to a one-dimensional array, a visual representation of the distribution of entities within the candidate segment, the distribution of entities based on the similarities between the features associated with the entities within the candidate segment.

In some examples of the method, apparatuses, and non-transitory computer-readable medium described herein, calculating the set of similarity scores between the seed segment and the set of candidate segments may include operations, features, means, or instructions for calculating, based on the set of candidate segment fingerprints and the seed segment fingerprint, a set of divergence scores between the seed segment and the set of candidate segments, calculating, based on the set of divergence scores and a set of confidence scores generated for the entities of the set of candidate segments using the set of cluster models, a set of combinatorial scores for the entities of the set of candidate segments, and calculating, based on the set of combinatorial scores for the entities of the set of candidate segments, the set of similarity scores.

In some examples of the method, apparatuses, and non-transitory computer-readable medium described herein, calculating the set of combinatorial scores may include operations, features, means, or instructions for identifying one or more first features associated with the entities of the set of candidate segments that may have higher contribution to respective similarity scores of the set of similarity scores relative to a contribution of one or more second features.

In some examples of the method, apparatuses, and non-transitory computer-readable medium described herein, identifying the segment of lookalike entities may include operations, features, means, or instructions for ranking entities the set of candidate segments based on the set of similarity scores and identifying the segment of lookalike entities based on the ranking.

A method for data processing is described. The method may include generating a vector for projecting a first segment of a set of segments to a one-dimensional array based on entities of the first segment and a set of feature vectors, where the entities of the first segment are associated with respective feature vectors, generating, based on the vector and a projection function, a projected vector corresponding to the first segment, generating, based on the projected vector, a first segment fingerprint indicative of a distribution of the entities within the first segment based on similarities between respective sets of features associated with the entities of the first segment, and generating, based on the first segment fingerprint and a seed segment fingerprint, a visual representation of the first segment fingerprint that displays the distribution of the entities within the first segment.

An apparatus for data processing is described. The apparatus may include a processor, memory coupled with the processor, and instructions stored in the memory. The instructions may be executable by the processor to cause the apparatus to generate a vector for projecting a first segment of a set of segments to a one-dimensional array based on entities of the first segment and a set of feature vectors, where the entities of the first segment are associated with respective feature vectors, generate, based on the vector and a projection function, a projected vector corresponding to the first segment, generate, based on the projected vector, a first segment fingerprint indicative of a distribution of the entities within the first segment based on similarities between respective sets of features associated with the entities of the first segment, and generate, based on the first segment fingerprint and a seed segment fingerprint, a visual representation of the first segment fingerprint that displays the distribution of the entities within the first segment.

Another apparatus for data processing is described. The apparatus may include means for generating a vector for projecting a first segment of a set of segments to a one-dimensional array based on entities of the first segment and a set of feature vectors, where the entities of the first segment are associated with respective feature vectors, means for generating, based on the vector and a projection function, a projected vector corresponding to the first segment, means for generating, based on the projected vector, a first segment fingerprint indicative of a distribution of the entities within the first segment based on similarities between respective sets of features associated with the entities of the first segment, and means for generating, based on the first segment fingerprint and a seed segment fingerprint, a visual representation of the first segment fingerprint that displays the distribution of the entities within the first segment.

A non-transitory computer-readable medium storing code for data processing is described. The code may include instructions executable by a processor to generate a vector for projecting a first segment of a set of segments to a one-dimensional array based on entities of the first segment and a set of feature vectors, where the entities of the first segment are associated with respective feature vectors, generate, based on the vector and a projection function, a projected vector corresponding to the first segment, generate, based on the projected vector, a first segment fingerprint indicative of a distribution of the entities within the first segment based on similarities between respective sets of features associated with the entities of the first segment, and generate, based on the first segment fingerprint and a seed segment fingerprint, a visual representation of the first segment fingerprint that displays the distribution of the entities within the first segment.

Some examples of the method, apparatuses, and non-transitory computer-readable medium described herein may further include operations, features, means, or instructions for normalizing the projected vector based on a zero-padding function, where the first segment fingerprint generated based on the normalized projected vector.

Some examples of the method, apparatuses, and non-transitory computer-readable medium described herein may further include operations, features, means, or instructions for calculating a set of similarity scores between the seed segment and the first segment based on the seed segment fingerprint and the first segment fingerprint.

Some examples of the method, apparatuses, and non-transitory computer-readable medium described herein may further include operations, features, means, or instructions for identifying similarities between the seed segment and the first segment based on the visual representation of the first segment fingerprint.

Some examples of the method, apparatuses, and non-transitory computer-readable medium described herein may further include operations, features, means, or instructions for generating, based on a set of vectors for projecting respective segments of the set of segments to respective one-dimensional arrays and the projection function, a set of projected vectors corresponding to the set of segments, generating, based on the set of projected vectors, a set of segment fingerprints based on similarities between respective sets of features associated with entities of the set of segments and the sets of features associated with the entities of the seed segment, and generating, based on the set of segment fingerprints and the seed segment fingerprint, a set of visual representations of the set of segment fingerprints that display the distribution of the entities within a respective segment.

In some examples of the method, apparatuses, and non-transitory computer-readable medium described herein, a dark band of the visual representation indicates a high similarity between the entities within the first segment.

In some examples of the method, apparatuses, and non-transitory computer-readable medium described herein, a light band of the visual representation indicates a low similarity between the entities within the first segment.

The following provides an overview of aspects of the present disclosure:

Aspect 1: A method for data processing, comprising: generating, using a set of cluster models and based at least in part on a seed segment and a corpus of entity data, a set of candidate segments, wherein a candidate segment of the set of candidate segments includes a plurality of entity identifiers from the corpus of entity data: generating, based at least in part on respective sets of features associated with entities of the set of candidate segments and sets of features associated with entities of the seed segment, a set of candidate segment fingerprints and a seed segment fingerprint, a segment fingerprint indicative of a distribution of entities within a segment based at least in part on similarities between features associated with entities within the segment: calculating a set of similarity scores between the seed segment and the set of candidate segments based at least in part on the seed segment fingerprint and the set of candidate segment fingerprints; and identifying, from the set of candidate segments and based at least in part on the set of similarity scores, a segment of lookalike entities corresponding to the seed segment.

Aspect 2: The method of aspect 1, wherein generating the set of candidate segments comprises: generating, using the set of cluster models, a set of confidence scores for the entities of the set of candidate segments, a confidence score of the set of confidence scores indicative of a probability of entity classification into a respective candidate segment of the set of candidate segments.

Aspect 3: The method of any of aspects 1 through 2, wherein a cluster model of the set of cluster models corresponds to a type of feature associated with the entities of the set of candidate segments.

Aspect 4: The method of any of aspects 1 through 3, wherein generating the set of candidate segment fingerprints and the seed segment fingerprint comprises: projecting, using a projection function, the entities of the candidate segment to a one-dimensional array, wherein the set of candidate segment fingerprints are generated based at least in part on the projection.

Aspect 5: The method of any of aspects 1 through 4, wherein generating the set of candidate segment fingerprints and the seed segment fingerprint comprises: generating, based at least in part on a projection of the entities of the candidate segment to a one-dimensional array, a visual representation of the distribution of entities within the candidate segment, the distribution of entities based at least in part on the similarities between the features associated with the entities within the candidate segment.

Aspect 6: The method of any of aspects 1 through 5, wherein calculating the set of similarity scores between the seed segment and the set of candidate segments comprises: calculating, based at least in part on the set of candidate segment fingerprints and the seed segment fingerprint, a set of divergence scores between the seed segment and the set of candidate segments: calculating, based at least in part on the set of divergence scores and a set of confidence scores generated for the entities of the set of candidate segments using the set of cluster models, a set of combinatorial scores for the entities of the set of candidate segments; and calculating, based at least in part on the set of combinatorial scores for the entities of the set of candidate segments, the set of similarity scores.

Aspect 7: The method of aspect 6, wherein calculating the set of combinatorial scores comprises: identifying one or more first features associated with the entities of the set of candidate segments that have higher contribution to respective similarity scores of the set of similarity scores relative to a contribution of one or more second features.

Aspect 8: The method of any of aspects 1 through 7, wherein identifying the segment of lookalike entities comprises: ranking entities the set of candidate segments based at least in part on the set of similarity scores; and identifying the segment of lookalike entities based at least in part on the ranking.

Aspect 9: A method for data processing, comprising: generating a vector for projecting a first segment of a set of segments to a one-dimensional array based at least in part on entities of the first segment and a set of feature vectors, wherein the entities of the first segment are associated with respective feature vectors: generating, based at least in part on the vector and a projection function, a projected vector corresponding to the first segment: generating, based at least in part on the projected vector, a first segment fingerprint indicative of a distribution of the entities within the first segment based at least in part on similarities between respective sets of features associated with the entities of the first segment; and generating, based at least in part on the first segment fingerprint and a seed segment fingerprint, a visual representation of the first segment fingerprint that displays the distribution of the entities within the first segment.

Aspect 10: The method of aspect 9, further comprising: normalizing the projected vector based at least in part on a zero-padding function, wherein the first segment fingerprint generated based at least in part on the normalized projected vector.

Aspect 11: The method of any of aspects 9 through 10, further comprising: calculating a set of similarity scores between the seed segment and the first segment based at least in part on the seed segment fingerprint and the first segment fingerprint.

Aspect 12: The method of any of aspects 9 through 11, further comprising: identifying similarities between the seed segment and the first segment based at least in part on the visual representation of the first segment fingerprint.

Aspect 13: The method of any of aspects 9 through 12, further comprising: generating, based at least in part on a set of vectors for projecting respective segments of the set of segments to respective one-dimensional arrays and the projection function, a set of projected vectors corresponding to the set of segments: generating, based at least in part on the set of projected vectors, a set of segment fingerprints based at least in part on similarities between respective sets of features associated with entities of the set of segments and the sets of features associated with the entities of the seed segment; and generating, based at least in part on the set of segment fingerprints and the seed segment fingerprint, a set of visual representations of the set of segment fingerprints that display the distribution of the entities within a respective segment.

Aspect 14: The method of any of aspects 9 through 13, wherein a dark band of the visual representation indicates a high similarity between the entities within the first segment.

Aspect 15: The method of any of aspects 9 through 14, wherein a light band of the visual representation indicates a low similarity between the entities within the first segment.

Aspect 16: An apparatus for data processing, comprising a processor: memory coupled with the processor; and instructions stored in the memory and executable by the processor to cause the apparatus to perform a method of any of aspects 1 through 8.

Aspect 17: An apparatus for data processing, comprising at least one means for performing a method of any of aspects 1 through 8.

Aspect 18: A non-transitory computer-readable medium storing code for data processing, the code comprising instructions executable by a processor to perform a method of any of aspects 1 through 8.

Aspect 19: An apparatus for data processing, comprising a processor: memory coupled with the processor; and instructions stored in the memory and executable by the processor to cause the apparatus to perform a method of any of aspects 9 through 15.

Aspect 20: An apparatus for data processing, comprising at least one means for performing a method of any of aspects 9 through 15.

Aspect 21: A non-transitory computer-readable medium storing code for data processing, the code comprising instructions executable by a processor to perform a method of any of aspects 9 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
generating, using a set of cluster models and based at least in part on a seed segment and a corpus of entity data, a set of candidate segments, wherein a candidate segment of the set of candidate segments includes a plurality of entity identifiers from the corpus of entity data;
generating, based at least in part on respective sets of features associated with entities of the set of candidate segments and sets of features associated with entities of the seed segment, a set of candidate segment fingerprints and a seed segment fingerprint, a segment fingerprint indicative of a distribution of entities within a segment based at least in part on similarities between features associated with entities within the segment;
calculating a set of similarity scores between the seed segment and the set of candidate segments based at least in part on the seed segment fingerprint and the set of candidate segment fingerprints; and
identifying, from the set of candidate segments and based at least in part on the set of similarity scores, a segment of lookalike entities corresponding to the seed segment.

2. The method of claim 1, wherein generating the set of candidate segments comprises:
generating, using the set of cluster models, a set of confidence scores for the entities of the set of candidate segments, a confidence score of the set of confidence scores indicative of a probability of entity classification into a respective candidate segment of the set of candidate segments.

3. The method of claim 1, wherein a cluster model of the set of cluster models corresponds to a type of feature associated with the entities of the set of candidate segments.

4. The method of claim 1, wherein generating the set of candidate segment fingerprints and the seed segment fingerprint comprises:
projecting, using a projection function, the entities of the candidate segment to a one-dimensional array, wherein the set of candidate segment fingerprints are generated based at least in part on the projection.

5. The method of claim 1, wherein generating the set of candidate segment fingerprints and the seed segment fingerprint comprises:
generating, based at least in part on a projection of the entities of the candidate segment to a one-dimensional array, a visual representation of the distribution of entities within the candidate segment, the distribution of entities based at least in part on the similarities between the features associated with the entities within the candidate segment.

6. The method of claim 1, wherein calculating the set of similarity scores between the seed segment and the set of candidate segments comprises:
calculating, based at least in part on the set of candidate segment fingerprints and the seed segment fingerprint, a set of divergence scores between the seed segment and the set of candidate segments;
calculating, based at least in part on the set of divergence scores and a set of confidence scores generated for the entities of the set of candidate segments using the set of cluster models, a set of combinatorial scores for the entities of the set of candidate segments; and
calculating, based at least in part on the set of combinatorial scores for the entities of the set of candidate segments, the set of similarity scores.

7. The method of claim 6, wherein calculating the set of combinatorial scores comprises:
identifying one or more first features associated with the entities of the set of candidate segments that have higher contribution to respective similarity scores of the set of similarity scores relative to a contribution of one or more second features.

8. The method of claim 1, wherein identifying the segment of lookalike entities comprises:
ranking entities the set of candidate segments based at least in part on the set of similarity scores; and
identifying the segment of lookalike entities based at least in part on the ranking.

9. An apparatus for data processing, comprising:
a processor;
memory coupled with the processor; and
instructions stored in the memory and executable by the processor to cause the apparatus to:
generate, using a set of cluster models and based at least in part on a seed segment and a corpus of entity data, a set of candidate segments, wherein a candidate segment of the set of candidate segments includes a plurality of entity identifiers from the corpus of entity data;
generate, based at least in part on respective sets of features associated with entities of the set of candidate segments and sets of features associated with entities of the seed segment, a set of candidate segment fingerprints and a seed segment fingerprint, a segment fingerprint indicative of a distribution of entities within a segment based at least in part on similarities between features associated with entities within the segment;
calculate a set of similarity scores between the seed segment and the set of candidate segments based at least in part on the seed segment fingerprint and the set of candidate segment fingerprints; and
identify, from the set of candidate segments and based at least in part on the set of similarity scores, a segment of lookalike entities corresponding to the seed segment.

10. The apparatus of claim 9, wherein the instructions to generate the set of candidate segments are executable by the processor to cause the apparatus to:
generate, using the set of cluster models, a set of confidence scores for the entities of the set of candidate segments, a confidence score of the set of confidence scores indicative of a probability of entity classification into a respective candidate segment of the set of candidate segments.

11. The apparatus of claim 9, wherein a cluster model of the set of cluster models corresponds to a type of feature associated with the entities of the set of candidate segments.

12. The apparatus of claim 9, wherein the instructions to generate the set of candidate segment fingerprints and the seed segment fingerprint are executable by the processor to cause the apparatus to:
project, using a projection function, the entities of the candidate segment to a one-dimensional array, wherein the set of candidate segment fingerprints are generated based at least in part on the projection.

13. The apparatus of claim 9, wherein the instructions to generate the set of candidate segment fingerprints and the seed segment fingerprint are executable by the processor to cause the apparatus to:
generate, based at least in part on a projection of the entities of the candidate segment to a one-dimensional array, a visual representation of the distribution of entities within the candidate segment, the distribution of entities based at least in part on the similarities between the features associated with the entities within the candidate segment.

14. The apparatus of claim 9, wherein the instructions to calculate the set of similarity scores between the seed segment and the set of candidate segments are executable by the processor to cause the apparatus to:
calculate, based at least in part on the set of candidate segment fingerprints and the seed segment fingerprint, a set of divergence scores between the seed segment and the set of candidate segments;
calculate, based at least in part on the set of divergence scores and a set of confidence scores generated for the entities of the set of candidate segments using the set of cluster models, a set of combinatorial scores for the entities of the set of candidate segments; and
calculate, based at least in part on the set of combinatorial scores for the entities of the set of candidate segments, the set of similarity scores.

15. The apparatus of claim 14, wherein the instructions to calculate the set of combinatorial scores are executable by the processor to cause the apparatus to:
identify one or more first features associated with the entities of the set of candidate segments that have higher contribution to respective similarity scores of the set of similarity scores relative to a contribution of one or more second features.

16. The apparatus of claim 9, wherein the instructions to identify the segment of lookalike entities are executable by the processor to cause the apparatus to:
rank entities the set of candidate segments based at least in part on the set of similarity scores; and
identify the segment of lookalike entities based at least in part on the ranking.

17. A non-transitory computer-readable medium storing code for data processing, the code comprising instructions executable by a processor to:
generate, using a set of cluster models and based at least in part on a seed segment and a corpus of entity data, a set of candidate segments, wherein a candidate segment of the set of candidate segments includes a plurality of entity identifiers from the corpus of entity data;
generate, based at least in part on respective sets of features associated with entities of the set of candidate segments and sets of features associated with entities of the seed segment, a set of candidate segment fingerprints and a seed segment fingerprint, a segment fingerprint indicative of a distribution of entities within a segment based at least in part on similarities between features associated with entities within the segment;
calculate a set of similarity scores between the seed segment and the set of candidate segments based at least in part on the seed segment fingerprint and the set of candidate segment fingerprints; and
identify, from the set of candidate segments and based at least in part on the set of similarity scores, a segment of lookalike entities corresponding to the seed segment.

18. The non-transitory computer-readable medium of claim 17, wherein
the instructions to generate the set of candidate segments are executable by the processor to:
generate, using the set of cluster models, a set of confidence scores for the entities of the set of candidate segments, a confidence score of the set of confidence scores indicative of a probability of entity classification into a respective candidate segment of the set of candidate segments.

19. The non-transitory computer-readable medium of claim 17, wherein a cluster model of the set of cluster models corresponds to a type of feature associated with the entities of the set of candidate segments.

20. The non-transitory computer-readable medium of claim 17, wherein the instructions to generate the set of candidate segment fingerprints and the seed segment fingerprint are executable by the processor to:
project, using a projection function, the entities of the candidate segment to a one-dimensional array, wherein the set of candidate segment fingerprints are generated based at least in part on the projection.
